(19) United States
(12) Patent Application Publication
(10) Pub. No.: US 2019/0303948 A1
(43) Pub. Date: Oct. 3, 2019

(54) PROVIDING CUSTOMER RELATIONSHIP MANAGEMENT DATA VIA A MESSAGING INTERFACE

(71) Applicant: Troops, Inc., New York, NY (US)

(72) Inventors: Daniel Reich, New York, NY (US); Greg Ratner, Brooklyn, NY (US); Aditya Pandyaram, Jersey City, NJ (US); Scott Britton, New York, NY (US)

(21) Appl. No.: 16/348,090

(22) PCT Filed: Nov. 20, 2017
(86) PCT No.: PCT/US17/62616

§ 371 Date: May 7, 2019

Related U.S. Application Data
(60) Provisional application No. 62/424,118, filed on Nov. 18, 2016.

(51) Int. Cl. G06Q 30/00; H04L 12/58; G06F 9/54; G06F 16/9035; G06F 16/9038

(52) U.S. Cl. CPC G06Q 30/016; H04L 51/02; G06F 16/9038; G06F 16/9035; G06F 9/542

(57) ABSTRACT

Systems and methods are provided for providing customer relationship management (“CRM”) data via a messaging interface. In some embodiments, a computing system can be used to generate and provide the messaging interface. The messaging interface can allow a user to provide user input (e.g., text input) and the computing system can access one or more databases that include CRM data in response to receiving the user input. The computing system can also obtain or receive, from the database, a subset of the CRM data relevant to the user input and store the subset of the CRM data. The computing system can also output, via a display device, the subset of the CRM data via the messaging interface. The computing system can also automatically (e.g., without receiving user input) obtain or receive the subset of the CRM data and output the subset of the CRM data via the messaging interface.

### CROSS-REFERENCE TO RELATED APPLICATIONS

This disclosure claims priority to U.S. Provisional Application No. 64/424,118, titled “Providing Customer Relationship Management Data Via a Messaging Interface” and filed Nov. 18, 2016, the entirety of which is hereby incorporated by reference herein.

### FIELD OF THE INVENTION

The present disclosure relates generally to relationship management data. More specifically, but not by way of limitation, this disclosure relates to providing customer relationship management (“CRM”) data via a messaging interface.

### BACKGROUND

Customer relationship management can include obtaining or analyzing data about one or more customers to manage a relationship with the customer. For example, various computing systems can be used to retrieve, compile, and analyze data for managing relationships with the one or more customers. The computing systems can also communicate the data as the data is retrieved, compiled, analyzed, or otherwise processed as part of the process of managing the relationships with the customers.

### SUMMARY

Various embodiments of the present disclosure relate to providing customer relationship management (“CRM”) data via a messaging interface.

In one embodiment, a user can provide user input via a messaging interface (e.g., Slack, Salesforce, Facebook, Skype, HipChat, Google, Zendesk, Oracle, Workday, Taleo, NetSuite, etc.) on a computing device and the user input can be communicated to another user. The user input can include information about a customer (e.g., a customer name or customer account number). In response, the computing device can extract one or more query parameters from the user input to generate a query and then search one or more databases or data sources (e.g., a Salesforce database, a Slack database, the user's e-mail, the user's calendar, a database including social media data, etc.) using the query to retrieve data relevant to the user input. A query parameter may be any sort of data or information that can be used to find information in the database. As an example, the user input can include a customer name and the computing device can retrieve data indicating a date of the last correspondence between the user and the customer. The computing device does so in a transparent manner and provides the relevant data in an intuitive manner, which appears similar to a user-to-user interaction. In some examples, the computing device can also generate one or more reminders that can be output to the user based on the user input (e.g., a reminder to contact the customer based on the customer name and the date of last correspondence between the user and the customer). In this example, the computing device can also output CRM data associated with the reminder, along with the reminder (e.g., the customer's name, account number, e-mail address, etc.). In this manner, the computing device can retrieve relevant CRM data based on user input provided by the user via the messaging interface and output data based on the user input. In some examples, the computing device can also transmit data to the one or more databases or data sources to be stored in the database or data source. As an example, the computing device can transmit user input received by the computing device or any other data to the database or data source and the database or data source can store the user input or other data. Thus, in some examples, the computing device can receive user input, analyze CRM data in a database, retrieve relevant CRM data based on the user input, output the relevant CRM, and update the database with data indicating the user input or any other data.

In one embodiment, a system of the present disclosure may include a processing device, a non-transitory computer-readable medium connected to the processing device, and a display device. The processing device can be configured to perform one or more operations including providing, via the display device, a messaging interface for receiving user input. The user input can include text, a phrase, a voice input (e.g., an oral command), etc. provided by the user of the system. The messaging interface can be a user interface that allows the user to provide user input that can be communicated to another user. For example, the user can chat with another user by providing user input to the messaging interface. The processing device can also be configured to extract a query parameter from the user input and generate a query based at least in part on the query parameter and access a database that includes CRM data or any other database or data source that includes any data. The CRM data can include customer information, customer account information, etc. The processing device can also be configured to search the database or data source using the query and retrieve or receive, from the database, a first subset of the CRM data relevant to the user input. The processing device may store the first subset of the CRM data. The processing device can further be configured to output, on the display device, the first subset of the CRM data via the messaging interface. The processing device can further be configured to transmit the user input received by the processing device to the database or data source and the database or data source can store the user input. In this manner, a user of the system can input a text, phrase, or a voice input into the system via the messaging interface to communicate with another user and the system may retrieve CRM data relevant to the text, phrase, or voice input, output the relevant CRM data to the user, and update a database with data indicating the text, phrase, or voice input.

In another embodiment, the processing device can automatically retrieve or receive, from the database, a subset of the CRM data (e.g., the processing device can retrieve or receive the CRM data in the absence of user input). For example, the processing device can automatically retrieve the subset of the CRM data at a particular time of day in the absence of user input and output, on the display device, the subset of the CRM data to the user. In this embodiment, the processing device may also generate one or more reminders that can be output to the user based on the retrieved subset of CRM data.

In some embodiments, the one or more reminders can also include the retrieved subset of CRM data. For example, the processing device can output CRM data associated with the reminder, along with the reminder (e.g., the customer's name, account number, e-mail address, etc.). In some such examples, the user may provide another user input after receiving the one or more reminders. In this embodiment, the processing device can store the other user input and output one or more other reminders or messages to the user in response to receiving the other user input. The one or more reminders can include a request for another user input (e.g., a request for the user to provide information such as, for example, data associated with a customer or data associated with the user's interaction or correspondence with the customer) and the processing device can automatically store user input received in response to the request or transmit the user input received in response to the request to one or more databases or data sources, which can store the received user input. In this manner, the user can chat with the system and the system can provide CRM data to the user, receive additional user input, store the additional user input from the user, communicate with the user based on the received additional user input, and update one or more databases based on received user input.

In some embodiments, the processing device can automatically retrieve or receive, from the database, a subset of the CRM data, process the data, and output the data or one or more reminders as described above based at least in part on a system preference input. The system preference input can represent data that can be received or obtained by the processing device (e.g., from the database, from another computing device, or from an indicia of user input). As an example, the system preference input can indicate a particular time of day or day to output the subset of the CRM data or the one or more reminders.

In some embodiments, the processing device can automatically retrieve or receive, from the database, a subset of the CRM data, process the data, and output the data or one or more reminders as described above based at least in part on an event. An event, as used herein, is any occurrence or other event, which can potentially be associated with the CRM data. As an example, the processing device can automatically retrieve and output the CRM data or a reminder in response to determining an upcoming deadline associated with the CRM data or in response to determining that new CRM data is input into the database.

These illustrative examples are mentioned not to limit or define the scope of this disclosure, but rather to provide examples to aid understanding thereof. Illustrative examples are discussed in greater detail in the Detailed Description that follows. Advantages offered by various embodiments may be further understood by examining this specification or by practicing one or more embodiments of the present subject matter.

### BRIEF DESCRIPTION OF THE DRAWINGS

FIG. 1 is a block diagram of an exemplary environment in which a computing device for providing customer relationship management data based on user input received via a messaging interface can operate according to one example.

FIG. 2 is a flow chart depicting an example of a process for providing customer relationship management data based on user input received via a messaging interface according to one example.

FIG. 3 is a flow chart depicting an example of a process for providing customer relationship management via a messaging interface according to one example.

FIG. 4 is a flow chart depicting an example of a process for providing customer relationship management data via a messaging interface according to one example.

### DETAILED DESCRIPTION

The following description recites various aspects and examples of retrieving customer relationship management (“CRM”) data based on user input provided via a messaging interface. Those of ordinary skill in the art will realize that the following description is illustrative only and is not intended to be in anyway limiting. Rather, the examples merely provide non-limiting examples of various methods and systems that are at least within the scope of the present disclosure. The subject matter to be claimed may be embodied in otherways, may include different elements or steps, and may be used in conjunction with other existing or future technologies. This description should not be interpreted as implying any particular order or arrangement between steps or elements except when the order of individual steps or arrangements of elements is explicitly described. The following description is to be read from the perspective of one of ordinary skill in the art; therefore, information well-known to the skilled artisan is not necessarily included.

One illustrative embodiment is a system that includes a processing device, a memory, and a display device. The processing device can be configured to perform one or more operations. The operations can include providing, via the display device, a messaging interface for receiving user input. The messaging interface can be a user interface that allows a user of the system to input or provide text, a phrase, voice input (e.g., an oral command), etc. In some examples, the user input can be communicated to another user. Thus, in some examples, users may communicate (e.g., chat) by providing user input via the messaging interface. The processing device can further be configured to access one or more databases that include CRM data such as, for example, customer information, customer account information, or any other data associated with a customer. The processing device can also be configured to retrieve, from at least one of the databases, a first subset of CRM data that is relevant to the user input. For example, the user input may include text that includes a customer name and the processing device can retrieve CRM data from the databases that is associated with the customer or customer name such as, for example, the customer's transaction history. The processing device can further be configured to store the first subset of CRM data in the memory and output on the display device, the first subset of CRM data via the messaging interface. In some examples, the processing device can further be configured to transmit data to the one or more databases, which can store the data. The data can correspond to user input received by the processing device via the messaging interface.

In this illustrative embodiment, a user of the system can communicate with another user by providing user input via the messaging interface and the system may retrieve CRM data relevant to the user input and output the relevant CRM data to the user.

In another embodiment, the system can retrieve and provide CRM data to the user in the absence of user input. For example, the system may periodically access one or more databases that include CRM data, retrieve a subset of the CRM data, and output the subset of the CRM data to the user automatically (e.g., regardless of receiving user input). The system may also automatically generate one or more reminders that can be output to the user based on the retrieved subset of CRM data. As an example, the system can generate and output a reminder to the user to contact a customer based on CRM data indicating a date of last correspondence between the user and the customer. As another example, the system can generate and output a reminder to the user to contact the customer based on CRM data indicating a deadline associated with the customer (e.g., a deadline for closing a deal with the customer). As still another example, the system can generate and output a reminder to the user indicating an event including, for example, a campaign deadline (e.g., an advertisement campaign deadline), an upcoming renewal date, a new customer or new data about a customer being input into the database, etc. In some examples, the system can determine a customer relationship management operation based on a reminder and/or an event and output the customer relationship management operation, along with the reminder. For instance, the system can determine that the user should e-mail or call the customer in response to determining that a deadline for closing a deal with the customer is approaching. In this example, the system can output a reminder indicating the upcoming deadline, along with data indicating that the user should e-mail or call the customer. In this manner, the system can automatically retrieve CRM data and output the CRM data or a notification that includes the CRM data to the user in the absence of user input.

In some examples, the user may provide another user input after receiving the one or more reminders. In some such examples, the system can store the other user input and output one or more additional reminders or notifications to the user in response to receiving the other user input. In some examples, the one or more additional reminders or notifications can include a request for additional user input (e.g., a request for the user to provide information such as, for example, data associated with the customer or data associated with the user's interaction or correspondence with the customer) and the system can automatically transmit the additional user input received in response to the request to one or more databases or data sources, which can store the received additional user input. In this manner, the user can chat with the system and the system can: provide CRM data via a reminder output the user; receive additional user input; store the additional user input; communicate with the user based on the received additional user input; and update one or more databases based on received user input.

In some embodiments, the system can automatically retrieve and provide CRM data or a reminder to the user in the absence of user input as described above and based at least in part on a system preference input. The system preference input can represent data that can be received or obtained by the system (e.g., from the database, from another computing device, or from an indicia of user input). As an example, the system preference input can indicate a particular time of day or day to output the subset of the CRM data or the one or more reminders.

In some embodiments, the system can automatically retrieve or receive, from the database, a subset of the CRM data, process the data, and output the data or one or more reminders as described above based at least in part on an event. An event, as used herein, is any occurrence or other event, which can potentially be associated with the CRM data. As an example, the system can automatically retrieve and output the CRM data or a reminder in response to determining an upcoming deadline associated with the CRM data or in response to determining that new CRM data is input into the database.

The following sections describe various additional features and examples with reference to the drawings in which like numerals indicate like elements, and directional descriptions are used to describe the illustrative examples but, like the illustrative examples, should not be used to limit the present disclosure.

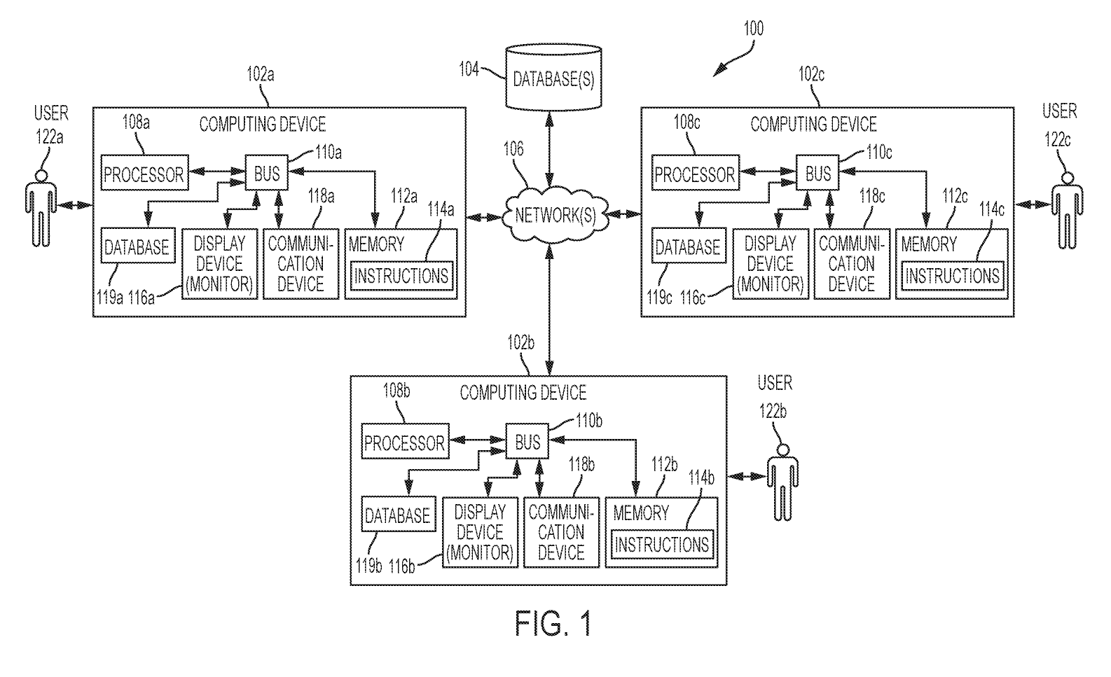

FIG. 1 is a block diagram of an exemplary environment 100 in which a computing device 102a-c for providing customer relationship management (“CRM”) data based on user input received via a messaging interface can operate. Each of the computing devices 102a-c is communicatively coupled to a database 104 in the exemplary environment 100 for communicating (e.g., transmitting and receiving) data. The exemplary environment 100 also includes a network 106 that facilitates communication of data by the computing devices 102a-c, the database 104, or any other device in the exemplary environment 100.

Each computing device 102a-c may include any computing device that can communicate with the exemplary environment 100. For example, each computing device 102a-c may send data to the exemplary environment 100 or a device in the exemplary environment to be analyzed, stored, processed, or output. In some examples, each computing device 102a-c is a mobile device (e.g., a mobile telephone, a smartphone, a PDA, a tablet, a laptop, etc.). In other examples, each computing device 102a-c is a non-mobile device (e.g., a desktop computer or another type of network device). Additional devices, such as server computers or cloud-based computers may be used in addition to or instead of the devices shown in FIG. 1.

In some embodiments, each of the computing devices 102a-c can include one or more components for acquiring, processing, and analyzing data. For example, each computing device 102a-c can include a processor 108a-c, a bus 110a-c, and a memory 112a-c. Each processor 108a-c can execute one or more operations for operating the computing devices 102a-c. The processors 108a-c can execute instructions 114a-c stored in the memory 112a-c to perform the operations. Non-limiting examples of the processor 108a-c include a Field-Programmable Gate Array (“FPGA”), an application-specific integrated circuit (“ASIC”), a microprocessor, etc.

Each processor 108a-c can be communicatively coupled to the memory 112a-c via the bus 110a-c. Each memory 112a-c may include any type of memory device that retains stored information when powered off. Non-limiting examples of the memory 112a-c include electrically erasable and programmable read-only memory (“EEPROM”), flash memory, or any other type of non-volatile memory. In some examples, at least some of the memory 112a-c can include a computer-readable medium from which the processor 108a-c can read instructions 114a-c. The computer-readable medium can include electronic, optical, magnetic, or other storage devices capable of providing the processor 108a-c with computer-readable instructions 114a-c or other program code. Non-limiting examples of a computer readable-medium include (but are not limited to) magnetic disk(s), memory chip(s), ROM, random-access memory (“RAM”), an ASIC, a configured processor, optical storage, or any other medium from which a computer processor can read instructions. The instructions can include processor-specific instructions generated by a compiler or an interpreter from code written in any suitable computer-programming language, including, for example, C, C++, C#, etc.

In some examples, each computing device 102a-c can include input/output interface components (e.g., a display device 116a-c and a communication device 118a-c). The computing device 102a-c can also include other input/output interface components such as a database 119a-c, a keyboard, a touch-sensitive surface, a mouse and additional storage. The database 119a-c of each computing device 102a-c can include CRM data or any other data. The CRM data can include a customer's information, customer's account information, or any data that can be used for managing customer relationships.

Each computing device 102a-c can transmit or receive data via a communication device 120a-c. In some examples, the communication device 120a-c can represent one or more of any components that facilitate a network connection. In some examples, the communication device 120a-c may be wireless and can include wireless interfaces such as IEEE 802.11, Bluetooth, or radio interfaces for accessing cellular telephone networks (e.g., transceiver/antenna for accessing a CDMA, GSM, UMTS, or other mobile communications network). In another example, the communication device 120a-c can be wired and can include interfaces such as Ethernet, USB, IEEE 1394, or a fiber optic interface. Each computing device 102a-c can transmit or receive data via the communication device 120a-c. In the example shown in FIG. 1, the computing devices 102a-c can transmit and receive data via a wireless interface. In other examples, the computing devices 102a-c can transmit and receive data via a wired interface.

The database 104 can include one or more databases that store data to be accessed or processed by any device in the exemplary environment 100 (e.g., the computing devices 102a-c or any other device that can be in the exemplary environment 100). In some examples, the database 104 can store a variety of different types of data organized in a variety of different ways and from a variety of different sources. For example, the database 104 can include CRM data or any other data. In some examples, the CRM data can be from various sources including, for example, Salesforce, Slack, Google, Gmail, Google Calendar, Microsoft Outlook, Microsoft Dynamics, SAP, Oracle, RelateIQ, Twitter, LinkedIn, Facebook, Skype, Zendesk, Workday, Taleo, NetSuite, etc. The database 104 may also store data that has been processed by one or more devices in the exemplary environment 100 (e.g., data that has been processed by computing devices 102a-c). In some examples, the database 104 may store data associated with one or more customer relation operations or processes. In still another example, the database 104 can store data associated with one or more templates, system preference inputs, user inputs, etc.

Communication within the exemplary environment 100 may occur on, or be facilitated by, the network 106, which includes one or more networks or uses one or more communications platforms or technologies suitable for transmitting data or communication signals. For example, the computing devices 102a-c and the database 104 can communicate (e.g., transmit or receive data) with each other via the network 106. In some examples, the exemplary environment 100 can include one or more of a variety of different types of networks, including a wireless network, a wired network, or a combination of a wired and wireless network.

In some examples, the memory 112a-c of each computing device 102a-c can include instructions 114a-c for causing the computing device 102a-c to generate a messaging interface and provide the messaging interface via the display devices 116a-c. The messaging interface can be any user interface for displaying or providing data and receiving user input (e.g., text, a phrase, or a voice input) from users 122a-c. As an example, the computing device 102a can generate the messaging interface and provide the messaging interface to a user 122a via display device 116a to allow the user 122a to provide the user input.

In some examples, the computing devices 102a-c may generate and provide a messaging interface (e.g., Salesforce, Slack, Facebook, Skype, HipChat, Google, Zendesk, Oracle, Workday, Taleo, NetSuite, etc.) to allow users 122a-c to provide user input that can be communicated between one or more devices in the exemplary environment 100. For example, the user 122a can input text to the computing device 102a through the messaging interface generated by the computing device 102a. The computing device 102a may transmit data indicating the text to another device in the exemplary environment 100, which can output the text to a user of the other device. As an example, the data can be transmitted to the computing device 102b and output via a messaging interface displayed via display device 116b to allow the user 122b to perceive (e.g., view or read) the text provided by the user 122a. As another example, the user 122a can provide a voice input to the computing device 102a through the messaging interface and data indicating the voice input can be transmitted by the computing device 102a to the computing device 102b to allow the user 122b to hear the voice input. Thus, in some examples, the messaging interfaces generated and provided by the computing device 102a-c can allow users 122a-c to communicate (e.g., chat) via the messaging interfaces.

The memory 112a-c of each computing device 102a-c can also include instructions for causing the computing device 102a-c to receive or obtain data from another computing device, from the database 104, from user input (e.g., if a user programs the computing device 102a-c to include the data), or from any other source. The data can include CRM data or other data. In some examples, each computing device 102a-c can receive or obtain data based on user input received via the messaging interface provided by the computing device 102a-c.

For example, the user 122a can provide user input to the computing device 102a via the messaging interface generated by the computing device 102a. While the user input may simply be a message to another user, the memory 112a of the computing device 102a can include instructions for causing the computing device 102a to extract one or more query parameters from the user input to generate a query (e.g., a query that can be used to search a database or data source). A query parameter may be any sort of data or information that can be used to find information in the database 104. The memory 112a of the computing device 102a can include instructions for causing the computing device 102a to search or access the database 104 in response to the user input (e.g., based on the query) and retrieve data associated with the user input or data that is otherwise relevant to the user input. As an example, the user input (e.g., the message to another user) includes a customer account number and the computing device 102a accesses CRM data in the database 104 (e.g., CRM data from Salesforce or Slack) and determines and retrieves a subset of the CRM data in the database 104 that may be relevant to the customer account number provided by the user. The database access and retrieval is seamless to the user, i.e., the user need not access the database (e.g., Salesforce) system in order for the data be retrieved. For example, the computing device 102a can retrieve a customer name associated with the customer account number, a customer address associated with the customer account number, a customer history associated with the customer account number, a transaction history associated with the customer account number, or any other CRM data in the database 104 associated with the customer account number. In some examples, the computing device 102a may also access the computing device 102b, determine, and retrieve data from the computing device 102b that may be relevant to the customer account number. For example, the database 119b of the computing device 102b may include CRM data associated with the customer account number (e.g., data indicating a meeting date with the customer associated with the customer account number) and the computing device 102a may retrieve the relevant CRM data from the computing device 102b.

As another example, the memory 112a can include instructions for causing the computing device 102a to transmit data indicating the user input to the database 104. The database 104 can transmit data associated with the user input or data that is otherwise relevant to the user input to the computing device 102a. For example, the user input may include a customer name, the computing device 102a can transmit data indicating the customer name to the database 104, and the database 104 can transmit CRM data relevant to the customer name or associated with the customer name (e.g., customer transaction history) to the computing device 102a. In some examples, the database 104 can also store data received from the computing device 102a (e.g., store data indicating user input received from the computing device 102).

In some examples, the computing devices 102a-c can store data in database 119a-c. In some examples, the data can be data obtained or received by the computing device 102a-c based on user input received by the computing device 102a-c. As an example, the computing device 102a may retrieve or obtain a subset of CRM data from the database 104 that is relevant to the user input provided by the user 122a and store the subset of CRM data in the database 119a.

The computing devices 102a-c can also output data. For example, the computing device 102a may retrieve or obtain a subset of CRM data that is associated with or relevant to user input provided by the user 122a and output the subset of CRM data to the user 122a via the messaging interface provided using the display device 116a. As an example, the computing device 102a may output, via the display device 116a, customer history data associated with a customer account number input into the messaging interface by the user 122a.

Thus, in some examples, the exemplary environment 100 can include computing devices 102a-c that can: i) generate and provide messaging interfaces to allow users 122a-c to communicate (e.g., chat) by providing user input via messaging interfaces; ii) retrieve CRM data relevant to the user input; and iii) output the relevant CRM data to the users 122a-c.

The memory 112a-c of each computing device 102a-c can also include instructions for causing the computing device 102a-c to automatically (e.g., without receiving user input) receive or obtain CRM data or other data from another computing device, from the database 104, from user input (e.g., if a user programs the computing device 102a-c to include the data), or from any other source. For example, the memory 112a can include instructions for causing the computing device 102a to automatically access CRM data stored in the database 104 at a particular time during the day, during a particular interval of time during the day, or at various times during the day. In this example, the computing device 102a can automatically access the CRM data stored in the database 104, retrieve the CRM data, analyze the CRM data, and output data to the user 122a in the absence of user input from the user 122a.

For example, the computing device 102a can automatically retrieve CRM data indicating a date associated with a customer (e.g., a closing date for a deal associated with the customer) and compare the closing date to a current date (e.g., the date that the computing device 102a automatically retrieves the data). The computing device 102a can determine a number of days between the dates and automatically output a reminder to the user 122a in response to determining that the number of days between the dates is below a threshold value. As another example, the computing device 102a can automatically retrieve data indicating the closing date for the deal associated with the customer and data indicating the date of the last correspondence between the user 122a and the customer. The computing device 102a can compare the closing date and the date of the last correspondence to determine a number of days between the dates and automatically output a reminder to the user 122a in response to determining that the number of days between the dates is above a threshold value. As still another example, the computing device 102a can query or access CRM data stored in the database 119a of the computing device 102a such as, for example, data indicating a date that a contract was sent out to a customer. The computing device 102a can compare the date that the contract was sent out to the current date and determine a number of days between the dates. The computing device 102a can then output a reminder or indicator to the user 122a in response to determining that the number of days is above a threshold value (e.g., the contract was sent out twenty days ago and should have been received back within three days). In this example, the computing device 102a can automatically output a reminder to the user 122a in response to determining that the number of days between the dates is above a threshold value. In this manner, the computing devices 102a-c can automatically retrieve CRM data or other data, process the data, and output data to the users 122a-c in the absence of user input from the users 122a-c.

In some examples, the user 122a may provide another user input after receiving the one or more reminders. For example, the user 122a can provide another user input indicating an update on a date of correspondence between the user 122a and the customer or an update on a status of a deal associated with the customer. In some such examples, the computing device 102a can store the other user input and output one or more additional reminders or notifications to the user in response to receiving the other user input. In some examples, the one or more additional reminders or notifications can include a request for additional user input (e.g., a request for the user 122a to provide information such as, for example, data associated with the customer or data associated with the user's interaction or correspondence with the customer) and the computing device 102a can automatically store the additional user input received in response to the request (e.g., in the database 119a) or transmit the additional user input received in response to the request to one or more databases or data sources (e.g., to the database 104), which can store the received additional user input.

As an example, the computing device can compare a number of days between a dosing date for a deal associated with a customer and a date of the last correspondence between the user 122a and the customer and output a reminder to the user 122a in response to determining that the number of days between the dates is above a threshold value as described above. The user 122a can provide additional user input indicating a status of a correspondence between the user 122a and the customer after receiving the reminder. The computing device 102a can store the additional user input (e.g., in the database 119a). The computing device 102 can then output one or more additional reminders that can include a request for user input indicating a date of the correspondence between the user 122a and the customer or an update on a status of the deal associated with the customer. The user 122a can provide user input including a response to the request to the computing device 102a (e.g., via the messaging interface) and the computing device 102a can store the data indicating the user input or transmit data indicating the user input to the database 104. In this manner, the computing device 102a can update data in one or more databases (e.g., CRM data in database 104) by automatically requesting a user input and transmitting data indicating the received user input to the one or more databases.

As another example, the computing device 102a can automatically retrieve data indicating a dosing date for a deal associated with a customer and data indicating the current date. In this example, the computing device 102a can compare the closing date and the current date to determine a number of days between the dates and automatically outputs a request for user input indicating whether the dosing date is accurate in response to determining that the number of days between the dates is below a threshold value. In this example, the user can provide user input in response to the request and the computing device 102a can store the user input (e.g., in the database 119a or 104). For instance, the user input can indicate an updated closing date for the deal and the computing device 102a can store the user input. As another example, the user input can indicate that the original closing date for the deal is accurate and computing device 102a can store the user input.

In some examples, the computing devices 102a-c can output one or more reminders as described above and output CRM data associated with the reminder, along with the reminder. For example, the computing device 102a can output a reminder to the user 122a in response to determining that the number of days between a closing date for a deal associated with a customer and the current date is below a threshold value. In this example, the computing device 102a can also retrieve and output CRM data about the customer, along with the reminder such as, for example, the customer's name, account number, e-mail address, telephone number, etc.

In some examples, the computing devices 102a-c can automatically retrieve CRM data or other data, process the data, and output the data to the users 122a-c in the absence of user input as described above based at least in part on a system preference input. The system preference input can represent data that can be received or obtained by the computing devices 102a-c (e.g., from the database 104, from another computing device, or from an indicia of user input). As an example, the computing device 102a can automatically retrieve CRM data indicating a closing date for a deal associated with a customer as described above. The system preference input may indicate a threshold number of days between a current date (e.g., the date that the computing device 102a automatically retrieves data) and a dosing date for a deal associated with a customer. The computing device 102a can compare the current date and the closing date and automatically output a reminder to the user 122a in response to determining that the number of days between the dates is below the system preference input (e.g., below the threshold number of days between the current date and the dosing date).

In some examples, the computing devices 102a-c can retrieve CRM data based on user input or retrieve CRM data automatically as described above based at least in part on a schedule or cadence of the users 122a-c. For example, the memory 112a can include instructions for causing the computing device 102a to store data associated with a schedule or cadence of the user 122a. The schedule of the user 122a can include one or more characteristics associated with the user 122a. As an example, the schedule of the user 122a can include an approximate time that the user 122a uses the computing device 102a, an interval or length of time during which the user 122a uses the computing device 102a, a period of time during which the user 122a provides user inputs via the messaging interface provided by the computing device 102a or any other characteristic associated with a schedule of the user 122a. In such examples, the computing device 102a can store data associated with the schedule of the user 122a and generate and provide messaging interfaces to the user 122a based on the schedule, retrieve CRM data based on the schedule, or output CRM data to the user based on the schedule. As an illustrative example, the user 122a provides user input associated with a customer account number every Friday and the computing device 102a can store data indicating that the user 122a provides user input associated with the customer account number based on this schedule. The computing device 102a can retrieve CRM data relevant to the customer account number every Friday and output the relevant CRM data to the user 122a every Friday. In some examples, users 122a-c can provide user input to configure or modify one or more schedules or cadences and the computing devices 102a-c can retrieve and output CRM data or one or more reminders, alerts, indicators, etc. based on the configured or modified schedule or cadence.

In some examples, the computing devices 102a-c can retrieve CRM data automatically or retrieve CRM data as described above based at least in part on a template input or system preferences provided by the users 122a-c. For example, the user 122a can provide a template input indicating a desired cadence, schedule, or pattern for receiving CRM data. The computing device 102a can retrieve CRM data and output the CRM data to the user 122a based on the desired schedule or pattern for receiving CRM data provided by the user 122a. As another example, the user 122a can provide user input indicating one or more system preferences to the computing device 102a. The computing device 102a can receive or obtain data (e.g., CRM data or other data) from another computing device, from the database 104, from user input (e.g., if a user programs the computing device 102a-c to include the data), or from any other source (e.g., without receiving user input) based on the system preferences. As an example, the system preferences may indicate a time of day that the computing device 102a can receive or obtain CRM data from another computing device or from the database 104.

In some examples, the computing devices 102a-c can retrieve and output CRM data automatically or output one or more reminders as described above based at least in part on an event. For example, the computing device 102a can automatically retrieve CRM data associated with an event such as, for example, a deadline for a campaign or other event (e.g., an advertisement campaign deadline), an upcoming renewal date, new CRM data being input into the database 104 (e.g., new customer information or new data about an existing customer that may potentially be assigned to the user 122a manually or automatically). In this example, the computing device 102a can retrieve CRM data associated with the event such as, for instance, a name or address of a new customer, the customer's reason for subscribing to a particular service or buying a product, an e-mail address of the customer, etc. In this example, the computing device 102a can automatically output a reminder or data indicating the event or CRM data associated with the event. In some examples, the computing devices 102a-can determine a customer relationship management operation based on a reminder or an event and output the customer relationship management operation. For example, the computing device 102a can determine that the user 122a should e-mail or call a customer in response to determining that a deadline for closing a deal with the customer is approaching (e.g., the number of days between the current date and the deadline for closing the deal is below a threshold value). In this example, the computing device 102a can output a reminder indicating the upcoming deadline, along with data indicating that the user 122a should e-mail or call the customer.

The memory 112a-c of each computing device 102a-c can also include instructions for causing the computing device 102a-c to execute one or more operations for querying data in a device in the exemplary environment 100 or for comparing data stored in one device in the exemplary environment 100 with data stored in another device in the exemplary environment 100. In some examples, the computing devices 102a-c can output an alarm or reminder in response to querying data in the exemplary environment 100 or comparing data in the exemplary environment 100.

For example, the computing device 102a can query or access CRM data stored in the database 119b of the computing device 102b such as, for example, data indicating an event associated with a customer (e.g., a calendar event associated with the customer or a meeting with the customer) or data indicating a correspondence with the customer. The computing device 102a can access or query the CRM data and output a reminder to the user 122a based on the CRM data. As an example, the computing device 102a can access data indicating a date of a recent meeting with the customer and a date of the last correspondence with the customer. The computing device 102a can compare the date of the recent meeting to the date of the last correspondence and output a reminder to the user 122a in response to determining that the date of the recent meeting with the customer is after the date of the last correspondence with the customer. In another example, the computing device 102a can compare the date of the recent meeting to the date of the last correspondence to determine a number of days between the dates. The computing device 102a may output the reminder to the user 122a in response to determining that the number of days between the dates is above a threshold value. In still another example, the computing device 102a can compare the dates and output the reminder to the user 122a in response to determining that: i) the date of the recent meeting with the customer is after the date of the last correspondence with the customer; and ii) a reminder associated with the meeting was not previously output to the user 122a.

As another example, the computing device 102a can query or access CRM data stored in the database 119a of the computing device 102a such as, for example, data indicating a recent meeting with the customer. The computing device 102a can output a reminder or indicator to the user 122a requesting user input indicating whether the user 122a would like to input notes associated with the recent meeting. In this example, the computing device 102a may automatically generate a graphical user interface for inputting the notes in response to receiving user input indicating that the user 122a would like to input the notes. In another example, the computing device 102a may automatically input the notes associated with the meeting in response to receiving user input indicating that the user 122a would like to input the notes (e.g., by analyzing an audio file associated with the meeting and using one or more speech-to-text methods or techniques).

In some examples, the computing devices 102a-c can output the alarm, indicator, or reminder by generating a task or other indicator associated with the alarm or reminder and displaying the indicator via the display device 116a-c. In this manner, the computing devices 102a-c can provide one or more reminders to users 122a-c based on data stored in one or more devices in the exemplary environment 100. In some examples, outputting an alarm or reminder based on CRM data in the exemplary environment 100 can enhance one or more processes for managing customer relationships (e.g., by determining a number of days between a meeting with a customer and correspondence with the customer and outputting a reminder to the user 122a-c in response to the determination).

In some examples, the memory 112a-c of each computing device 102a-c can also include instructions for causing the computing device 102a-c to execute one or more operations for retrieving CRM data. For example, the memory 112a can include instructions for causing the computing device 102a to retrieve CRM data from the database 104 (e.g., data from a Salesforce database or a Slack database), analyze the CRM data and perform one or more diagnostic operations on the data to determine one or more steps for managing or improving relationships with the one or more customers in the database 104.

In some examples, the memory 112a-c of each computing device 102a-c can include instructions for causing the computing device 102a-c to execute one or more operations for generating and outputting a reminder, task, or other indicator as described above. In some examples, the memory 112a-c of each computing device 102a-c can also include instructions for causing the computing device 102a-c to modify or configure a reminder, task, or other indicator based on user input. For example, the user 122a can provide a template input to the computing device 102a indicating a desired cadence, schedule, or pattern for receiving a reminder, task, or other indicator.

In some examples, the memory 112a-c of each computing device 102a-c can include instructions for causing the computing device 102a-c to execute one or more operations for causing the computing device 102a-c to execute one or more operations for querying data in a device in the exemplary environment 100 or for comparing data stored in one device in the exemplary environment 100 with data stored in another device in the exemplary environment 100. In some examples, the computing devices 102a-c can train a machine-learning algorithm based on the data.

For example, the computing device 102a can query or access CRM data stored in the database 104. The computing device 102a can then train a machine-learning algorithm to determine or predict one or more customer relation operations or processes based on the CRM data. A machine-learning algorithm can be a machine-learning model that uses statistical learning algorithms that are used to estimate or approximate functions that depend on a large number of inputs in a non-linear, distributed, and parallel manner. An example of a machine-learning algorithm includes, but is not limited to, a neural network. A computer learning machine-learning algorithm can include an interconnected group of nodes, called neurons. A machine-learning algorithm can include input nodes, output nodes, and intermediary nodes. In some examples, the connections between each node are weighted with a set of adaptive weights that are tuned by a learning algorithm, and are capable of approximating non-linear functions of their inputs.

For example, the computing device 102a accesses CRM data in the database 104 indicating a number of days after an initial contact with a customer that a user 122a-c follows up with the customer. The computing device 102a also accesses CRM data in the database 104 indicating a dosing percentage associated with each user 122a-c and/or customer (e.g., a percentage or amount of times that a user 122a closes on a deal with a customer). In this example, the computing device 102a can train the machine-learning algorithm to determine or predict a number of days after an initial contact with a customer that a user 122a-c should follow up with a subsequent customer. For instance, the computing device 102a trains the machine-learning algorithm to determine that the user 122a follows up with each customer within five days of an initial contact with the customer and that the user 122a has a dosing percentage of eighty percent. The computing device 102a also trains the machine-learning algorithm to determine that the user 122b follows up with each customer within twenty days of an initial contact with the customer and that the user 122b has a dosing percentage of thirty-five percent. The computing device 102a also trains the machine-learning algorithm to determine that the user 122c follows up with each customer within fifteen days of an initial contact with the customer and that the user 122b has a dosing percentage of fifty percent. In this example, the computing device 102a can train the machine-learning algorithm to determine or predict that a user 122a-c should follow up with a customer within approximately five days after an initial contact with the customer.

Continuing with this example, the computing device 102a can automatically output a reminder, indicator, task, or other data indicating a customer relation operations or processes based on the CRM data based on data determined using the machine-learning algorithm (e.g., output a reminder, along with CRM data associated with the customer and data indicating that the user 122a should follow up with a customer in response to determining that it has been four days since the first contact between the user 122a and a customer).

In some examples, the memory 112a-c of each computing device 102a-c can include instructions for causing the computing device 102a-c to execute one or more operations for generating one or more reports that can include graphical displays or any data obtained or processed by any device in the exemplary environment 100. For instance, the computing device 102 can generate and output a report indicating a number of alerts generated and output to users 122a-c (e.g., a number of alerts generated and output to users 122a-c within a time period or interval). As another example the computing device 102 can generate and output a report indicating an amount of CRM data updated in database 104 (e.g., a number of deals associated with various customers updated by the computing devices 102a-c).

Although the exemplary environment 100 of FIG. 1 is depicted as having a certain number of components, in other examples, the exemplary environment 100 has any number of additional or alternative components. Further, while FIG. 1 illustrates a particular arrangement of the computing devices 102a-c, the database 104, and the network 106, various additional arrangements are possible.

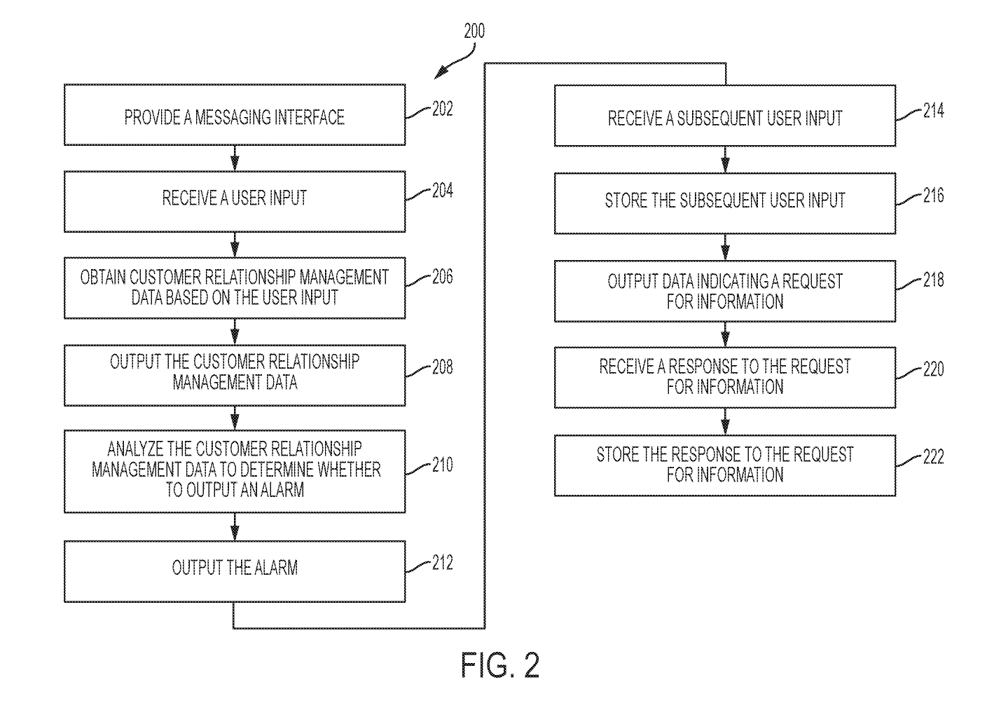

FIG. 2 is a flow chart depicting an example of a process 200 for providing customer relationship management data based on user input received via a messaging interface. In some embodiments, one or more steps shown in FIG. 2 may be omitted or performed in a different order. Similarly, in some examples, additional steps not shown in FIG. 2 may also be performed. In some embodiments, one or more processing devices implement operations depicted in FIG. 2 by executing suitable program code. For illustrative purposes, the process 200 is described with reference to the exemplary environment 100 of FIG. 1, but other implementations are possible.

In block 202, a messaging interface is provided. For example, a computing device 102a can generate the messaging interface and provide the messaging interface via a display device 116a. The messaging interface can be a user interface for providing data and receiving user input.

In block 204, user input is received. For example, a user 122a may provide user input to the computing device 102a via a messaging interface provided by the computing device 102a (e.g., the messaging interface provided in block 202). The user input can include text, phrase, a voice input, etc.

In block 206, CRM data is obtained based on the user input. For example, the user 122a can provide user input to the computing device 102a (e.g., in block 204) and the computing device 102a can extract one or more query parameters from the user input to generate a query (e.g., a query that can be used to search a database or data source). The computing device 102a can then access or search a database 104 in response to the user input (e.g., access or search the database 104 by using the query to retrieve data relevant to the user input). The database 104 can store different types of data from various sources. For example, the database 104 can include CRM data, such as, for example, a customer's information, customer's account information, etc., or any other data associated with one or more customers. The CRM data can be from various sources including, for example, Salesforce, Slack, Google, Gmail, Google Calendar, Microsoft Dynamics, SAP, Oracle, RelateIQ, Twitter, LinkedIn, Facebook, Skype, Zendesk, Workday, Taleo, NetSuite, etc. In some examples, the computing device 102a can access the database 104 and retrieve data that is associated with the user input or is otherwise relevant to the user input.

As an example, the user input provided by the user 122a can include a customer name and the computing device 102a can access CRM data in the database 104 to determine and retrieve a subset of the CRM data in the database 104 (e.g., CRM data from Salesforce or Slack) that may be relevant to, or associated with, the customer name provided by the user. For example, the computing device 102a can retrieve a customer account number associated with the customer name, a customer address associated with the customer name, a customer history associated with the customer name, a transaction history associated with the customer name, or any other CRM data in the database 104 associated with the customer name.

In some examples, the computing device 102a may retrieve the subset of CRM data from the database 104 that is relevant to the user input provided by the user 122a and store the subset of CRM data in a database 119a of the computing device 102a.

In some examples, the computing device can also transmit data indicating the user input to the database 104, which can store the data indicating the user input.

In block 208, CRM data is output to the user. For example, the computing device 102a can output the subset of CRM data obtained in response to user input (e.g., CRM obtained or received in block 206). As an example, the computing device 102a retrieves the subset of the CRM data in the database 104 that may be relevant to, or associated with, a customer name provided by the user 122a and outputs the subset of the CRM data via the display device 116a.

In block 210, CRM data is analyzed to determine whether to output an alarm to the user 122a.

For example, the computing device 102a can obtain (e.g., in block 206) a subset of CRM data that may be relevant to, or associated with, user input provided by the user 122a. The subset of CRM data can include data about an event associated with a customer (e.g., a calendar event associated with the customer or a meeting with the customer) or data about correspondence with the customer. The computing device 102a can analyze the subset of CRM data and determine whether to output an alarm based on the subset of CRM data. As an example, the computing device 102a can access data indicating a date of a recent meeting with the customer and a date of the last correspondence with the customer. The computing device 102a can compare the date of the recent meeting to the date of the last correspondence and determine that an alarm is to be output in response to determining that the date of the recent meeting with the customer is after the date of the last correspondence with the customer. In another example, the computing device 102a can compare the date of the recent meeting to the date of the last correspondence to determine a number of days between the dates. The computing device 102a can determine that an alarm is to be output in response to determining that the number of days between the dates is above a threshold value. In still another example, the computing device 102a can compare the dates and determine than an alarm is to be output in response to determining that: i) the date of the recent meeting with the customer is after the date of the last correspondence with the customer; and ii) an alarm associated with the meeting was not previously output to the user 122a.

In block 212, the alarm is output. For example, the computing device 102a can output the alarm or reminder by generating a task or other indicator associated with the alarm or reminder and displaying the indicator via the display device 116a. Thus, in some examples, the computing devices 102a can provide one or more reminders, alarms, or indicators or otherwise output data to the user 122a based on CRM data to enhance one or more processes for managing customer relationships (e.g., by determining a number of days between a meeting with a customer and correspondence with the customer and outputting a reminder to the user 122a-c in response to the determination).

In block 214, a subsequent user input is received. In some examples, the computing device 102a can receive a subsequent user input from the user 122a after the alarm is output (e.g., in block 212). For example, the user 122a can provide a subsequent user input to the computing device 102a (e.g., via the messaging interface) and the subsequent user input can indicate an update on a status of a correspondence between the user 122a and the customer or a date of an upcoming meeting between the user 122a and the customer.

In block 216, the subsequent user input (e.g., the subsequent user input received in block 214) is stored. In some examples, the computing device 102a can store the subsequent user input (e.g., in database 119a). In another example, the computing device 102a can transmit data indicating the subsequent user input to another computing device or to one or more databases or data sources (e.g., the database 104), which can store the subsequent user input.

In block 218, data is output indicating a request for information. In some examples, the computing device 102a can output data (e.g., one or more notifications) to the user 122a in response to receiving the subsequent user input (e.g., in block 214). In some examples, data can include a request for additional user input or information. As an example, the computing device 102a can output data that includes a request for user input indicating a date of the correspondence between the user 122a and the customer or an update on a status of a deal associated with the customer. In another example, the computing device 102a can output data that includes a request for any user input or any information.

In block 220, a response to the request for information is received. In some examples, the computing device 102a receives the response to the request for information from the user 122a via user input provided via the messaging interface. As an example, the user 122a can provide additional user input indicating a status of a correspondence between the user 122a and the customer or the update on a status of a deal associated with the customer.

In block 222, the response to the request for information is stored (e.g., the response received in block 220). In some examples, the computing device 102a stores the response to the request for information (e.g., in database 119a). In another example, the computing device 102a transmits data indicating the response to the request for information to one or more other computing devices or databases (e.g., the database 104), which can store the response to the request for information.

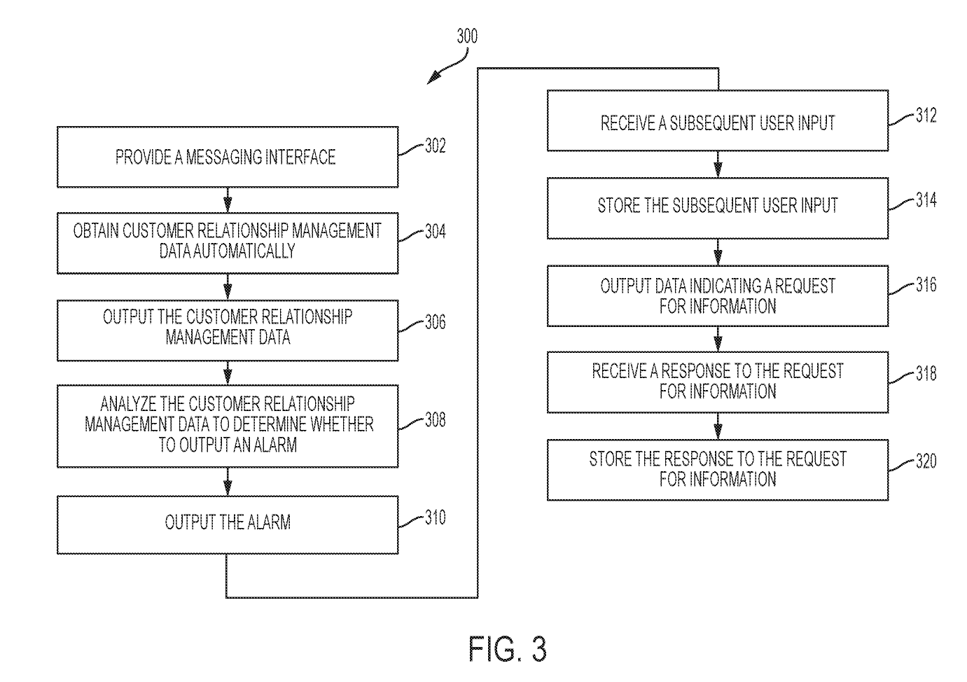

FIG. 3 is a flow chart depicting an example of a process 300 for providing customer relationship management data via a messaging interface. In some embodiments, one or more steps shown in FIG. 3 may be omitted or performed in a different order. Similarly, in some examples, additional steps not shown in FIG. 3 may also be performed. In some embodiments, one or more processing devices implement operations depicted in FIG. 3 by executing suitable program code. For illustrative purposes, the process 300 is described with reference to the exemplary environment 100 of FIG. 1, but other implementations are possible.

In block 302, a messaging interface is provided. For example, a computing device 102a can generate the messaging interface and provide the messaging interface via a display device 116a. The messaging interface can be a user interface for providing data or receiving user input.

In block 304, CRM data is obtained automatically. For example, the computing device 102a can automatically receive or obtain CRM data or other data from the database 104. The database 104 can store different types of data from various sources. For example, the database 104 can include CRM data, such as, for example, a customer's information, customer's account information, etc., or any other data associated with one or more customers. The CRM data can be from various sources including, for example, Salesforce, Slack, Google, Gmail, Google Calendar, Microsoft Dynamics, SAP, Oracle, RelateIQ, Twitter, LinkedIn, Facebook, Skype, etc.

As an example, the computing device 102a can automatically retrieve CRM data (e.g., data from Salesforce or Slack in the database 104) at a particular time during the day, during a particular interval of time during the day, or at various times during the day. In some examples, the computing device 102a can automatically retrieve or receive the CRM data regardless of whether the computing device 102a receives user input (e.g., from a user 122a).

In block 306, CRM data is output to the user. For example, the computing device 102a can output the CRM data automatically retrieved (e.g., CRM data obtained or received in block 304) via the display device 116a. For example, the computing device 102a can output CRM data indicating a date associated with a customer (e.g., a closing date for a deal associated with the customer).

In block 308, CRM data is analyzed to determine whether to output an alarm to the user 122a.

For example, the computing device 102a can automatically obtain CRM data (e.g., in block 304). The CRM data can include data about a date associated with a customer (e.g., a closing date for a deal associated with the customer) or a date of a correspondence between the user 122a and the customer. The computing device 102a can compare the dosing date to a current date (e.g., the date that the computing device 102a automatically retrieves the data). The computing device 102a can determine a number of days between the dates and determine that an alarm is to be output in response to determining that the number of days between the dates is below a threshold value.

As another example, the CRM data automatically obtained by the computing device 102a can indicate the dosing date for the deal associated with the customer and a date of the last correspondence between the user 122a and the customer. The computing device 102a can compare the dosing date and the date of the last correspondence to determine a number of days between the dates and determine that an alarm is to be output in response to determining that the number of days between the dates is above a threshold value.

In block 310, the alarm is output. For example, the computing device 102a can output the alarm or reminder by generating a task or other indicator associated with the alarm or reminder and displaying the indicator via the display device 116a. In some examples, in block 310, outputting the alarm or reminder can also include outputting CRM data to the user. For example, the alarm or reminder can include CRM data automatically retrieved (e.g., CRM data obtained or received in block 304).

In block 312, a subsequent user input is received. In some examples, the computing device 102a can receive a subsequent user input from the user 122a after the alarm is output (e.g., in block 310). For example, the user 122a can provide a subsequent user input to the computing device 102a (e.g., via the messaging interface) and the subsequent user input can indicate an update on a status of a correspondence between the user 122a and the customer or a date of an upcoming meeting between the user 122a and the customer.

In block 314, the subsequent user input (e.g., the subsequent user input received in block 214) is stored. In some examples, the computing device 102a can store the subsequent user input (e.g., in database 119a). In another example, the computing device 102a can transmit data indicating the subsequent user input to another computing device or to one or more databases or data sources (e.g., the database 104), which can store the subsequent user input.

In block 316, data is output indicating a request for information. In some examples, the computing device 102a can output data (e.g., one or more notifications) to the user 122a in response to receiving the subsequent user input (e.g., in block 312). In some examples, data can include a request for additional user input or information. As an example, the computing device 102a can output data that includes a request for user input indicating a date of the correspondence between the user 122a and the customer or an update on a status of a deal associated with the customer. In another example, the computing device 102a can output data that includes a request for any user input or any information.

In block 318, a response to the request for information is received. In some examples, the computing device 102a receives the response to the request for information from the user 122a via user input provided via the messaging interface. As an example, the user 122a can provide additional user input indicating a status of a correspondence between the user 122a and the customer or the update on a status of a deal associated with the customer.

In block 320, the response to the request for information is stored (e.g., the response received in block 318). In some examples, the computing device 102a stores the response to the request for information (e.g., in database 119a). In another example, the computing device 102a transmits data indicating the response to the request for information to one or more other computing devices or databases (e.g., the database 104), which can store the response to the request for information.

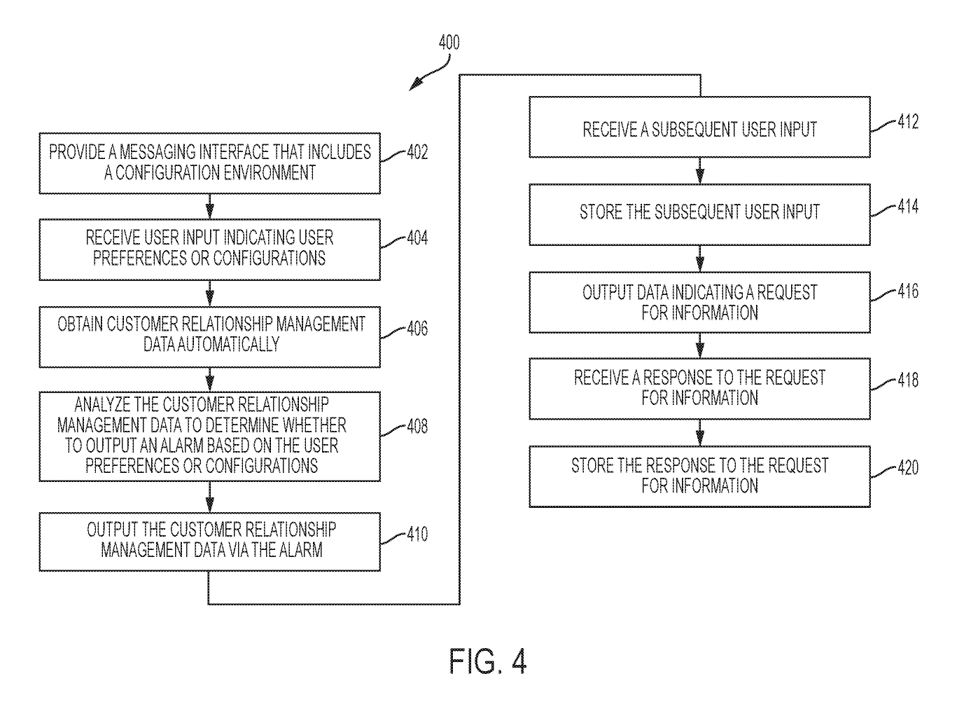

FIG. 4 is a flow chart depicting an example of a process 400 for providing customer relationship management data via a messaging interface. In some embodiments, one or more steps shown in FIG. 4 may be omitted or performed in a different order. Similarly, in some examples, additional steps not shown in FIG. 4 may also be performed. In some embodiments, one or more processing devices implement operations depicted in FIG. 4 by executing suitable program code. For illustrative purposes, the process 400 is described with reference to the exemplary environment 100 of FIG. 1, but other implementations are possible.

In block 402, a messaging interface is provided. For example, a computing device 102a can generate the messaging interface and provide the messaging interface via a display device 116a. The messaging interface can be a user interface for providing data to a user 122a or receiving user input from the user 122a. In some examples, the messaging interface can include a configuration environment that includes one or more interfaces for receiving a template input from the user 122a. The template input can correspond to a user preference or user configuration, which can indicate a desired cadence, schedule, or patter for retrieving or obtaining data (e.g., CRM data or other data) from another computing device, from the database 104, or from any other source. In another example, the template input can correspond to a user preference or configuration that indicates a desired cadence, schedule, or patter for providing data to the user 122a.

In block 404, user input is received indicating user preferences or configurations. In some examples, the user 122a provides user input corresponding to a template input, which indicates the user's preferences or configurations. As described above, the template input indicates a desired cadence, schedule, or pattern for retrieving or obtaining data or for providing data to the user 122a.

In block 406, CRM data is obtained automatically. For example, the computing device 102a can automatically receive or obtain CRM data or other data from the database 104. The database 104 can store different types of data from various sources. For example, the database 104 can include CRM data, such as, for example, a customer's information, customer's account information, etc., or any other data associated with one or more customers. The CRM data can be from various sources including, for example, Salesforce, Slack, Google, Gmail, Google Calendar, Microsoft Dynamics, SAP, Oracle, RelateIQ, Twitter, LinkedIn, Facebook, Skype, Zendesk, Workday, Taleo, NetSuite, etc.

In some examples, the computing device 102a can automatically obtain CRM data based at least in part on the template input provided by the user 122a (e.g., in block 404). As an example, the template input provided by the user indicates a time of day or a time of a month that the computing device 102a can receive or obtain CRM data from another computing device or from the database 104 and the computing device 102a automatically obtains CRM data from the other computing device or the database 104 based on the template input.

In block 408, CRM data is analyzed to determine whether to output an alarm to the user 122a.

For example, the computing device 102a can automatically obtain CRM data (e.g., in block 406). The CRM data can include data about a date associated with a customer (e.g., a closing date for a deal associated with the customer) or a date of a correspondence between the user 122a and the customer. The computing device 102a can compare the dosing date to a current date (e.g., the date that the computing device 102a automatically retrieves the data). The computing device 102a can determine a number of days between the dates and determine that an alarm is to be output in response to determining that the number of days between the dates is below a threshold value.

As another example, the CRM data automatically obtained by the computing device 102a can indicate the dosing date for the deal associated with the customer and a date of the last correspondence between the user 122a and the customer. The computing device 102a can compare the dosing date and the date of the last correspondence to determine a number of days between the dates and determine that an alarm is to be output in response to determining that the number of days between the dates is above a threshold value.

In block 410, the CRM data is output via the alarm. For example, the computing device 102a can generate an alarm or reminder that includes a task or other indicator associated with the alarm or reminder. The alarm or reminder can also include the CRM data obtained by the computing device 102a (e.g., in block 406). The computing device 102a can output the alarm or reminder, along with the obtained CRM data by displaying the alarm and the obtained CRM data via the display device 116a. In this manner, the computing device 102a can output obtained CRM data based on user configurations and preferences indicating a desired cadence, schedule, or pattern for retrieving or obtaining data or for providing data to the user 122a and output the CRM data, along with an alarm, in response to determining that the alarm is to be provided to the user.

In block 412, a subsequent user input is received. In some examples, the computing device 102a can receive a subsequent user input from the user 122a after the alarm is output (e.g., in block 410). For example, the user 122a can provide a subsequent user input to the computing device 102a (e.g., via the messaging interface) and the subsequent user input can indicate an update on a status of a correspondence between the user 122a and the customer or a date of an upcoming meeting between the user 122a and the customer.

In block 414, the subsequent user input (e.g., the subsequent user input received in block 412) is stored. In some examples, the computing device 102a can store the subsequent user input (e.g., in database 119a). In another example, the computing device 102a can transmit data indicating the subsequent user input to another computing device or one or more databases or data sources (e.g., the database 104), which can store the subsequent user input.

In block 416, data is output indicating a request for information. In some examples, the computing device 102a can output data (e.g., one or more notifications) to the user 122a in response to receiving the subsequent user input (e.g., in block 412). In some examples, data can include a request for additional user input or information. As an example, the computing device 102a can output data that includes a request for user input indicating a date of the correspondence between the user 122a and the customer or an update on a status of a deal associated with the customer. In another example, the computing device 102a can output data that includes a request for any user input or any information.

In block 418, a response to the request for information is received. In some examples, the computing device 102a receives the response to the request for information from the user 122a via user input provided via the messaging interface. As an example, the user 122a can provide additional user input indicating a status of a correspondence between the user 122a and the customer or the update on a status of a deal associated with the customer.

In block 420, the response to the request for information is stored (e.g., the response received in block 418). In some examples, the computing device 102a stores the response to the request for information (e.g., in database 119a). In another example, the computing device 102a transmits data indicating the response to the request for information to one or more other computing devices or databases (e.g., the database 104), which can store the response to the request for information.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system comprising:
a processing device; and
a non-transitory computer-readable medium communicatively coupled to the processing device, wherein the processing device is configured to perform operations comprising:
providing, via a display device, a messaging interface for receiving user input;
receiving user input via the messaging interface;
extracting a query parameter from the user input and generating a query based in part on the query parameter;
retrieving a subset of customer relationship management (“CRM”) data relevant to the user input from a database by searching the database using the query; and
outputting the subset of CRM data via the messaging interface.

2. The system of claim 1, wherein the processing device is further configured to:
determine whether to output an alarm by analyzing the subset of CRM data;
output, via the display device, the alarm in response to determining to output the alarm;
receive, via the messaging interface and in response to outputting the alarm, a subsequent user input indicating an update to the CRM data; and
store the subsequent user input in the database.

3. The system of claim 2, wherein the processing device is further configured to:
output a request for user input indicating the update to the CRM data in response to determining to output the alarm; and
receive, via the messaging interface and in response to outputting the request for user input, the subsequent user input indicating the update to the CRM data.

4. The system of claim 1, wherein the processing device is further configured to:
retrieve a first subset of CRM data from the database in the absence of user input; and
output, via the messaging interface, the first subset of CRM data.

5. The system of claim 4, wherein the processing device is further configured to retrieve the first subset of CRM data from the database in the absence of user input by:
automatically accessing the database at a particular time to obtain the first subset of CRM data from the database, and wherein the processing device is further configured to output the first subset of CRM data via the messaging interface at the particular time.

6. The system of claim 4, wherein the first subset of CRM data indicates a date associated with a customer and the processing device is further configured to:
compare the date associated with the customer and a current date to determine a number of days between the date associated with the customer and the current date; and
output a reminder via the messaging interface in response to determining that the number of days between the date associated with the customer and the current date is below a threshold.

7. The system of claim 4, wherein the first subset of CRM data indicates a date associated with a customer and the processing device is further configured to:
compare the date associated with the customer and a date of a correspondence with the customer to determine a number of days between the date associated with the customer and the date of the correspondence with the customer; and
output a reminder via the messaging interface in response to determining that the number of days between the date associated with the customer and the date of the correspondence with the customer is above a threshold.

8. The system of claim 4, wherein the processing device is further configured to:
retrieve the first subset of CRM data from the database in the absence of user input based on data indicating a user cadence, the user cadence indicating a schedule of a user associated with the system; and
output the first subset of CRM data via the messaging interface based on the schedule of the user.

9. The system of claim 8, wherein the user cadence indicates an approximate time that the user uses the system or a period of time during which the user provides user input to the system.

10. The system of claim 4, wherein the processing device is further configured to retrieve the first subset of CRM data from the database in the absence of user input by determining whether new CRM data is input into the database and wherein the processing device is further configured to output, in response to determining that new CRM data is input into the database, the first subset of CRM data via the messaging interface, the first subset of CRM data comprising the new CRM data.

11. The system of claim 1, wherein the user input comprises a text, a phrase, or a voice input.

12. A method comprising:
providing, by a processor and via a display device, a messaging interface for receiving user input;
receiving, by the processor, user input via the messaging interface;
extracting, by the processor, a query parameter from the user input;
generating, by the processor, a query based in part on the query parameter;
retrieving, by the processor, a subset of customer relationship management (“CRM”) data relevant to the user input from a database by searching the database using the query; and
outputting, by the processor and via the messaging interface, the subset of CRM data.

13. The method of claim 12, further comprising:
determining, by the processor, whether to output an alarm by analyzing the subset of CRM data;
outputting, by the processor and via the display device, the alarm in response to determining to output the alarm;
receiving, by the processor and in response to outputting the alarm, a subsequent user input indicating an update to the CRM data via the messaging interface; and
storing, by the processor, the subsequent user input in the database.

14. The method of claim 12, wherein the subset of CRM data indicates a date associated with a customer, the method further comprising:
comparing, by the processor, the date associated with the customer and a current date to determine a number of days between the date associated with the customer and the current date; and
outputting, by the processor, a reminder via the messaging interface in response to determining that the number of days between the date associated with the customer and the current date is below a threshold.

15. The method of claim 12, wherein the subset of CRM data indicates a date associated with a customer, the method further comprising:
comparing, by the processor, the date associated with the customer and a date of a correspondence with the customer to determine a number of days between the date associated with the customer and the date of the correspondence with the customer; and
outputting, by the processor, a reminder via the messaging interface in response to determining that the number of days between the date associated with the customer and the date of the correspondence with the customer is above a threshold.

16. The method of claim 12, further comprising:
retrieving, by the processor, a first subset of CRM data from the database in the absence of user input; and
outputting, by the processor and via the messaging interface, the first subset of CRM data.

17. The method of claim 16, wherein retrieving the first subset of CRM data from the database in the absence of user input comprises:
automatically accessing, by the processor, the database at a particular time to obtain the first subset of CRM data from the database; and
outputting, by the processor, the first subset of CRM data via the messaging interface at the particular time.

18. The method of claim 16, further comprising:
retrieving, by the processor, the first subset of CRM data from the database in the absence of user input based on data indicating a user cadence, the user cadence indicating a schedule of a user associated with the system; and
outputting, by the processor, the first subset of CRM data via the messaging interface based on the schedule of the user.

19. The method of claim 16, further comprising:
retrieving, by the processor, the first subset of CRM data from the database in the absence of user input by determining, by the processor, whether new CRM data is input into the database; and
outputting, by the processor and in response to determining that new CRM data is input into the database, the first subset of CRM data via the messaging interface, the first subset of CRM data comprising the new CRM data.

20. The method of claim 12, wherein the user input comprises a text, a phrase, or a voice input.
